(19) United States
(12) Patent Application Publication
(10) Pub. No.: US 2010/0212597 A1
(43) Pub. Date: Aug. 26, 2010

(54) J bale feeder

(76) Inventor: John Burr Wolfe, Falls Village, CT (US)

Correspondence Address: John Burr Wolfe, 80 Amy Road, Falls Village, CT, 06031, US

(21) Appl. No.: 12/378,990

(22) Filed: Feb. 23, 2009

(51) Int. Cl. A01K 5/01

(52) U.S. Cl. 119/58; 119/61.31

(57) ABSTRACT

The J Bale Feeder is designed to minimize waste when feeding round bales to a small number of animals and/or to a variety of species, and to eliminate the need for expensive round bale handling equipment at the site where the animals are fed. The feeder consists of a V-shaped round bale cradle on wheels with a roof, a grate below the bale to catch falling hay and a hitch convenient for a regular sized pick-up or even smaller utility vehicle. To further minimize waste, the V-shaped cradle has adjustable openings for the animals to access the bale. A grated, hinged door in the back of the cradle, which opens wide to allow easy loading, combined with a similar grate on the front of the cradle, ensures that animals eat from the adjustable openings rather than the ends of the bale.

### CROSS-REFERENCE TO RELATED APPLICATIONS

Not applicable

### STATEMENT REGARDING FEDERALLY SPONSORED RESEARCH FOR DEVELOPMENT

Not applicable

### REFERENCE TO SEQUENCE LISTING A TABLE OR A COMPUTER PROGRAM LISTING COMPACT DISC APPENDIX

Not applicable

### BACKGROUND OF INVENTION

The purpose of the J Bale Feeder is to make it possible for more people to raise their own food on a small scale by making it less wasteful to feed round bales to a small number of animals, eliminating the need for expensive round bale handling equipment at the site where the animals are fed, and having one feeder that works well for animals of many different species and personalities, including sheep, cows, calves, and even goats.

Feeding round bales instead of small square bales is cheaper and less time consuming because there is more hay in a round bale. Due to the round shape and the orientation of the layers of hay a round bale sheds water and thus does not need to be covered until the animals start pulling it apart. The drawbacks of feeding round bales include the need for a tractor with some kind of round bale handling attachments where the animals are fed, waste of hay as animals take as much as they want and drop most of it on the ground, and animal-specific feeders as sheep, goats, cows and calves require different kinds of feeders.

Some, but not all, drawbacks to feeding round bales are addressed by other inventions. The bale ring 5921202 is a type of round bale feeder that works well for large cows but it does not work well for smaller livestock because they can get inside it and mess up the hay. This type of feeder does not work well for a few cows because fewer animals eat less hay so there is more time for the bale to get rained or snowed on after the animals pull the bale apart. There is an ideal number of animals for this type of feeder and the J Bale Feeder is designed for fewer than this number.

The portable round bale feeder 3906901 is a portable round bale feeder on wheels, eliminating the need for a tractor where the animals are. However, the other drawbacks of feeding round bales remain: the portable round bale feeder 3906901 is not well set up for conserving hay because animals can easily pull hay out of it onto the ground where they can soil the hay, it doesn't work well for small numbers of animals because the hay can get rained on, and small animals can get inside with the hay.

Cone feeders conserve hay by preventing the animals from stepping on the hay they drop, but cone feeders are too tall for small livestock and too tall to be made portable while loaded with hay so you must load the bale where the animals are fed which requires a tractor with a loader. In addition there is no way to adjust the spaces through which the animals access the bale making it not adaptable to animals of different sizes and personalities. Also available is the combination round bale feeder 5496145. This is portable when empty, but not with a round bale in it so a tractor with a loader is still necessary where the animals are fed. The combination feeder also has the same problem as most other feeders, namely it is too easy for animals too get hay on the ground where they walk causing excessive waste.

To make it possible for more people to efficiently feed small numbers of animals of varying size and personalities without needing round bale handling equipment (most people who sell round bales load them) I propose a round bale feeder that can be pulled easily while loaded over rough ground by a small pickup or SUV or even a Subaru, has a roof above the bale too keep the bale dry for as long as it takes for few animals and/or small livestock to eat it, has adjustable spaces through which a variety of types of animals can eat the bale, has a grate between the feeder and the ground to catch dropped hay, and is designed to prevent animals from access to the ends of the bale before rest of the bale is gone.

### BRIEF SUMMARY OF INVENTION

The J Bale Feeder is a portable round bale feeder on wheels. It has a frame with horizontal members extending from the rear forward and at least one cross member connecting the side members. A hitch is attached to the front of the feeder for attaching the feeder to a vehicle. One or more axles are attached to the frame between the hitch and the rear of the feeder. Attached horizontally to the frame is a grate extending from side to side and from the rear forward, having spaces large enough for fine bits of hay to fall through, but small enough to prevent substantial amounts of hay from falling through. Above this grate and frame work is a row of V shaped members with the points down, centered between the sides of the frame, and in a straight line extending from the rear forward with the tips of the Vs out above the sides forming a rack in which a round bale can be placed, and supports for a roof above the bale. At the forward most part of this rack is a grate extending vertically and from side to side with spaces too small for animals to eat through. The rear most V shaped member forms a frame work for a light door extending vertically and from side to side covered with a grate with spaces too small for animals too eat through. When this door is closed it prevents animals from accessing the bale from the end of the bale towards the back of the feeder while the grate on the front of the feeder prevents animals from accessing the bale from the front so the animals must eat through the spaces between the sides of the V shaped members. This helps conserve hay because when animals can access the ends of a round bale they usually pull the bale apart trying to get to the fresher hay in the middle of the bale. The V shaped members are spaced so that a large cow can eat from between the sides of them, but not too easily, so when the animal drops hay it falls on the grate below which is positioned such that an animal eating from it is in a more natural position than when the animal was eating from the bale. This and the fact that it is easier for animals to eat the fallen hay than to pull more hay from the bale causes animals to clean up after themselves. Between the sides of the V shaped members extending parallel to them are moveable or removable members that can be moved or removed to adjust the size of the spaces through which the animals can access the bale for different sized animals or to make the bale more difficult to access for extraordinarily messy animals.

The feeder can be towed with a small pickup, SUV, or even a Subaru, to a place where round bales are stored. A round bale can be easily loaded through the opened back door with tractor. The door is then closed, and the feeder is towed to where the animals will be fed, unhooked, and left alone with the animals until the bale is gone. A round bale has twenty to thirty times the amount of hay of a normal square bale, so if your animals eat one square bale per day, a round bale could last nearly a month.

### BRIEF DESCRIPTION OF DRAWINGS

FIG. 1 shows the whole feeder from the left rear corner.

FIG. 2 shows a close up of the left rear corner showing animals eating through the adjustable spaces provided by this invention.

FIG. 3 shows the feeder being loaded with hay while hooked to a small truck.

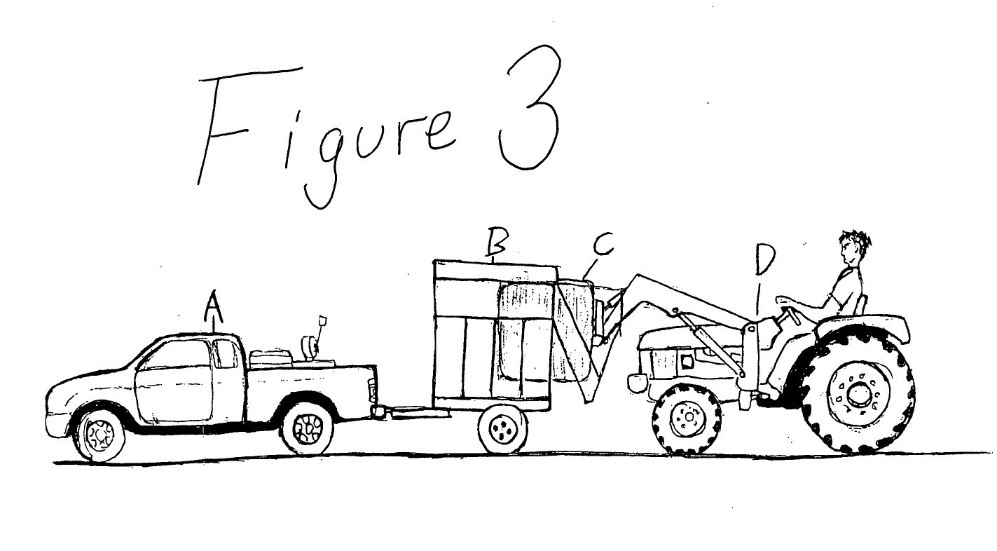

### DETAILED DESCRIPTION OF INVENTION

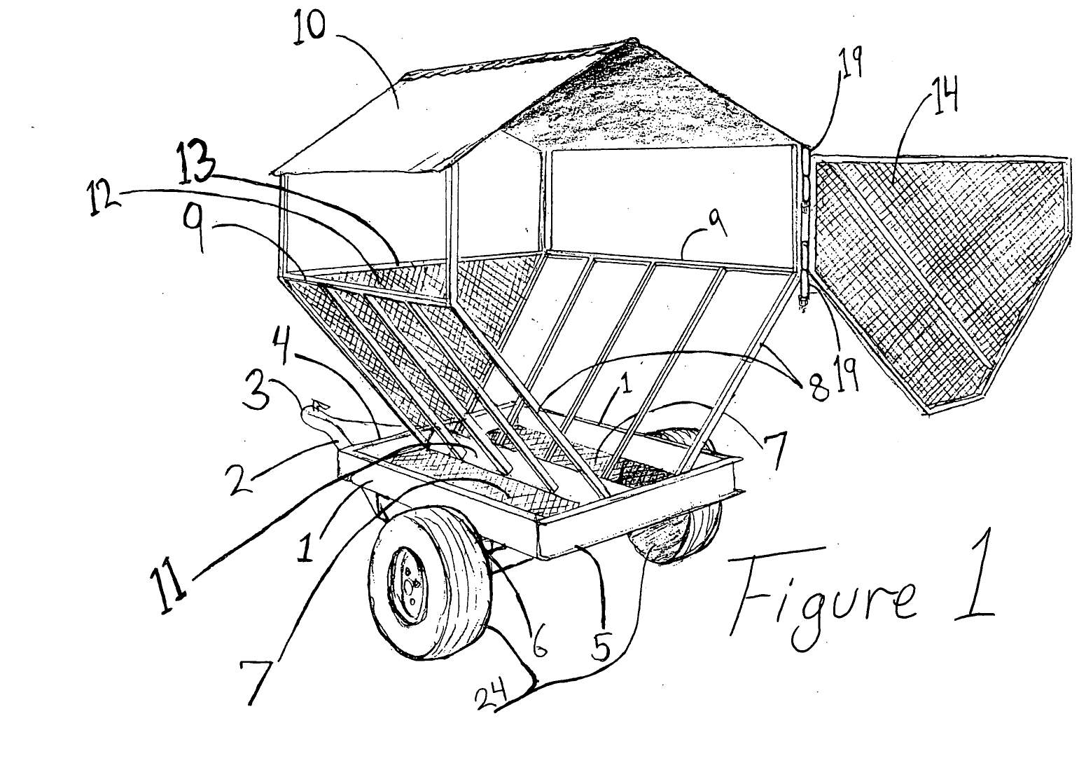

FIG. 1 is a view of the feeder from the back left corner with the door opened. From this view a person skilled in making this sort of contraption can see the whole feeder and most of the parts good enough to understand it and build it. The side members of the frame (1) are positioned horizontally, parallel to the ground, extending from the rear towards the front. There are many different dimensions and materials these could be made of, but 1½″ by 6″ channel iron 1 foot longer than the length of the round bales used, positioned on edge, with the flanges towards the inside of the feeder are ideal. The 6″ channel iron is strong enough to hold the feeder together but not too heavy. It is important not to oversize the materials because the usefulness of the invention depends on it being light enough to pull easily with the weight of a round bale.

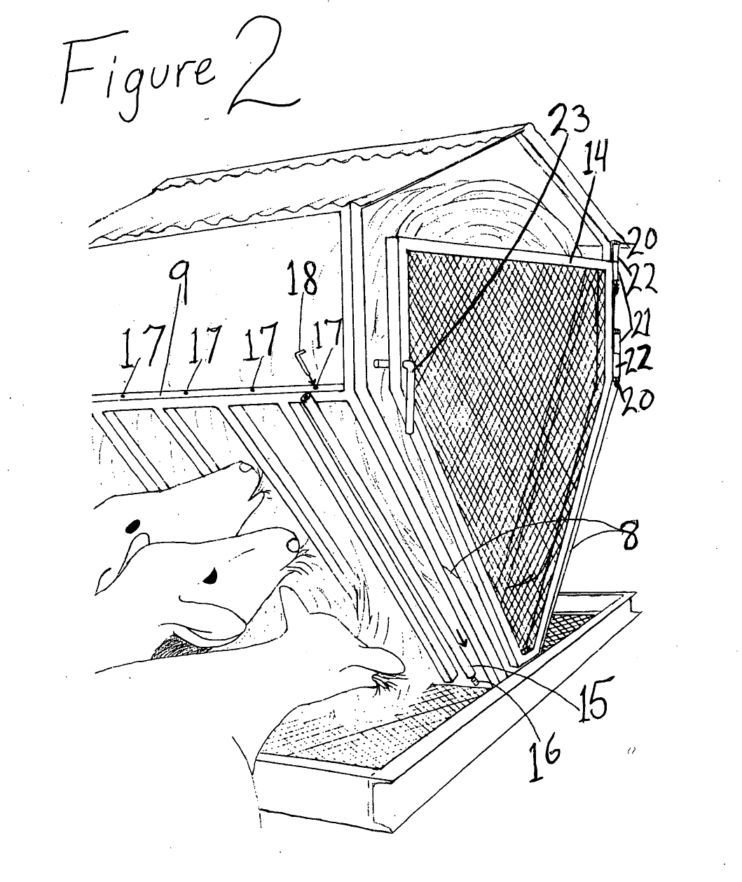

The flanges are pointed in for two reasons, (see FIG. 2) to prevent animals from pushing each other into the sharp edge of the flanges and to help keep hay in the bottom of the feeder. As hay is pulled out of the bottom of the feeder the upper flange catches the hay that the animal does not have a firm hold on and it falls back into the bottom of the feeder where it stays clean and dry.

Towards the front of the side members are one or more members (2) made of a strong material that connect a hitch to the frame of the feeder. These must be strong enough to pull the feeder over rough ground. There are lots of simple configurations in which these can be attached depending on what type of hitch is used, the height of the hitch on the vehicle used to tow the feeder, and the height of the bottom of the feeder. One good way to attach the hitch (2) is 1″ by 4″ channel iron welded to the bottom of each side member (1) with the flanges in extending from about a foot back from the front of the side member, angled inward towards the front of the feeder to a point forming a V. This configuration is common on small trailers and standard hitches (3) of most types are designed to be welded or bolted to the point of the V provided the angle of the V matches the angle of the desired hitch. The reason for attaching to the bottom of the frame members (1) is because a common height for hitches on small trucks is 20″, with the 6″ channel iron frame members (1) on top this puts the top of the side member at 26″ which is a good height for most animals to lift their head over to eat. The height and sizes in this description should not limit this invention. There are other dimensions that could work almost as well. The reason for attaching these members (2) back from the front of the side members (1) is to keep the feeder short enough to navigate sharp corners, and to strengthen the feeder by attaching (2) to a front cross member if a front cross member is used. One or more crossmembers (4 and 5) are necessary to connect the side members. Some hitch configurations may serve as a front cross member if they connect the side members good enough, and the axle (6) may help depending on what kind is used, but a cross member of some sort should be used towards the rear as this feeder is likely to see some rough use. Six-inch channel iron the same as the side members is cheap and strong and easily welded to the side members, but many other things could work as well. Ideally a crossmember (4 and 5) the same height and width as the side members should be used at the front and rear of the side members attaching them and providing support for the rest the feeder.

The bottom of the feeder is a grate of some kind (7) with spaces large enough for fine particles of hay and water to pass through but small enough to prevent substantial amounts of hay from falling through to the ground. Expanded metal works well because its cheap and can be welded easily, but a plate with holes or wire mesh or even plastic would work as long as it can be fastened securely to the bottom of the side and cross members. The purpose of this grate is to support hay that falls from the bale as the animals eat and provide a trough of sorts that is easy for the animals to eat such fallen hay from without allowing the animals to step on it or spread feces through it. It is important that the manufacturer understand the purpose of the grate, as the rest of the feeder must be constructed in a way that allows the grate to work.

Above this grate (7) is a row of V shaped members (8) with the points down, centered between the side members, and in a row extending from the rear towards the front. The tips of the V-shaped members are up and outward towards the sides forming a rack in which a round bale can be placed. The upper tips of the V-shaped members are in two lines, one on each side extending from the rear forward. There is a horizontal member (9) on each side running front to back connecting the tips of these V-shaped members to strengthen this rack and provide support for a roof (10). These V-shaped members must be made of something strong enough to support the weight of a round bale and big enough for a round bale to fit in. There are different sized round bales. ⅛ by 1½ by 1½ steel tubing works well for most bales, but it makes the feeder heavy. If smaller bales are used try using lighter materials. The angle of the V-shaped members is important, if the angle is too small the round bales wont fit as well and the feeder could be too tall. If the angle is too big the space between the side members of the frame and the bale will be smaller making it harder for animals too eat from the bottom of the feeder and easier to eat from the bale. This defeats the purpose of the design. It is important to make it easier to eat from the grate than from the bale, as this is what keeps the animals from wasting what they drop.

The V shaped members must be supported by something strong enough to support the bale and all the parts of the feeder above the grate. A six inch piece of angle iron ¼″ thick (11) with the corner up and the edges down, extending from the rear towards the front welded to crossmembers (4 and 5) works well. The pieces that form the V-shaped members can easily be welded to this. Another way would be to attach the V-shaped member to the side members of the frame with vertical members but this would more complicated and expensive. The rack of V-shaped members should be slightly longer than the length of the round bales used.

At the forward most part of the rack there is a grate or a plate (12) or something made of a material that animals cannot eat through. This protects the end of the bale; animals tend to get wasteful if they can get at the ends of the bale. Expanded metal works well for this for the same reasons it works well for the bottom of the feeder. There should be a crossmember of some sort (13) at the front of the rack of V-shaped members and about half way up the bale. This should be very strong because the bale might hit this hard during loading. The V-shaped members should be spaced such that a large cow can eat from between them but not too easily. The rear most V forms a frame for a light door (14) that when it is closed it extends vertically and from side to side. This should be made from a material that animals cannot eat through. The expanded metal suggested for the bottom of the feeder works well for this also.

The door should have hinges (19) that allow it to swing at least 90 degrees to the back of the feeder but it would be best if it swung 270 degrees all the way to the side of the feeder so when it is open people, tractors, or animals cant run into it. The hinges should be strong. Of the many ways hinges are made one strong simple way ideal for this invention is this: A bolt (20) is placed through two short pieces of pipe, one of the pipes, (21) is welded to the door and one (22) to the feeder, see FIG. 2 for a close up view of hinges. At least two of these hinges are necessary. A latch is also necessary to keep the door closed. Look at FIG. 2 for an example of a simple latch (23) but not the only kind that could be used on this contraption—a piece of round stock stuck through a hole in the side of the door opposite the hinge. On the out side of the door the stock is bent straight down while on the inside it is to one side so that when the door is closed and the back of the stock is down the front of the stock is in front of the V shaped member that acts as a door jam preventing the door from going back or opened. To open the door just turn the backside of the stock until the front of the stock is not in front of the V shaped member and pull back. The back of the stock should be heavier than the front so the weight of it pulls down with enough force to keep the latch in the right position. This type of latch is strong, simple, and can be used with one hand with mittens on. This is important because this feeder will most likely be used in the winter when pasture becomes unavailable.

The roof (10) should be high enough to accommodate a bale but not higher. The roof should be slightly wider and longer than the bale. The supports for the roof should be strong enough to support the roof. Depending on the angle of the V-shaped members the roof could be mounted directly on top of the V-shaped members as long as there is room for the bale.

Between the V-shaped members are moveable or removable members (15) parallel to the V-shaped members. The purpose of these is to make the spaces through which the animals can access the bale adjustable. If the animals are pulling more hay from the bale than they eat causing the bottom of the feeder to get over full, just make the space smaller by adding or moving these members. This is a good feature to have for feeding goats because it prevents animals from eating a hole through the bale and going in the bale. Drawing 2 shows a simple cheap configuration for these members—a chunk of round stock (16) or anything else that fits into the end of the pipe (15) that is welded or otherwise fastened between the V-shaped members to whatever is used to support the bottoms of the V-shaped members. A horizontal member (9) is for the upper tip of the V-shaped members to connect to. A hole (17) is drilled through this member (9) between the V-shaped member parallel to them. The end of the pipe (15) can be set on (16) with (16) inside (15). Then the other end of the pipe can be held under the hole (17) while the other hand drops a pin through the hole 17 into the end of the pipe (15) so the pipe can't move. To remove the pipe, just repeat this process backwards. This is a cheap easy way to do this. One good thing about this way of doing it is that you can remove the pipe (15) while under pressure. If an animal gets a leg stuck in the feeder or if goat gets its horn stuck just pull the pin and release it. There are many other ways to make these some of which might work better but this is cheap and simple. The method for making these members should not limit the invention. What is important is that there are removable or movable members as this is what makes the feeder adaptable to animals of varying size, species, and personalities.

What is claimed is:

1. A round bale feeder on wheels having a frame with horizontal members on each side extending from the rear toward the front and at least one crossmember connecting the side members.
A hitch attached to the front of the feeder for attaching it to a vehicle.
One or more axles attached to the frame between the hitch and the rear of the feeder.

2. A grate attached horizontally to the frame extending from side to side and from the rear of the feeder toward the front which has spaces large enough for fine particles to fall through but small enough to prevent substantial amounts of hay from falling through.

3. A row of V shaped members positioned above the grate described in claim 2 forming a rack in which a round bale could be placed.

4. A rack described in claim 3 positioned above a grate described in claim 2 such that hay that falls from the rack lands on the grate.

5. The rack described in claim 3 is positioned above the grate described in claim 2 and shaped such that a bale resting on the V shaped members is more difficult for animals to pull hay out of than it is for animals to eat from the grate, making the animals clean up what they drop before taking another bite from the bale.

6. The rack described in claim 3 is low enough an wide enough relative to the grate described in claim 2 that it prevents animals from stepping on the grate and soiling hay, but still high enough above this grate to allow animals to eat from the grate comfortably.

7. The spaces between the V shaped members in claim 3 are large enough for a large cow to eat hay through.

8. Moveable or removable members in the spaces described in claim 7 for adjusting the spaces through the animals can access the bale.

9. A screen or grate prevents animals from accessing the bale from the front.

10. A door at the rear of the feeder prevents animals from accessing the bale from the rear.
The door can be opened to place a round bale in the feeder with normal round bale handling equipment.

11. A roof positioned on top of the feeder to keep the hay dry.
